(19) United States
(12) Patent Application Publication
(10) Pub. No.: US 2022/0414690 A1
(43) Pub. Date: Dec. 29, 2022

(54) TWO-TIERED FORECASTING

(71) Applicant: NCR Corporation, Atlanta, GA (US)

(72) Inventors: Oliver Stohr, Atlanta, GA (US); Saadh Ahmed, Atlanta, GA (US); Edgar Rojas, Atlanta, GA (US)

(21) Appl. No.: 17/362,198

(22) Filed: Jun. 29, 2021

(51) Int. Cl. G06Q 30/02; G06Q 10/04

(52) U.S. Cl. CPC G06Q 30/0202; G06Q 10/04

(57) ABSTRACT

History data of an enterprise is passed as input to an initial forecasting model and forecast data over a period of time is produced for a controlled data item that is being forecasted. Additional forecasting models are then processed in parallel using the history data and the forecast data produced by the initial model as input to the additional models. Each additional model comprises different tuning parameters for forecasting the controlled data item. For each given interval within the period, a forecast value is selected as an optimal forecast value for that given interval by calculating a mean absolute percentage error rate for all of the models, and selecting the forecast value produced by the model having the smallest deviation from the mean. The selected forecast values for each of interval are assembled as optimal forecast data during the period and provided as an optimal forecast.

### BACKGROUND

Accurate forecasting models are a necessity for businesses. Retailers rely on forecasting for supply of merchandise, customer demand, financing, staff hiring, media replenishment, and many other activities.

Some forecasting models can be very accurate and useful to a business, but poor accuracy is of little value to the business.

One problem with developing a forecasting model is that the accuracy of any model is dependent upon the input data supplied. Many business spend a lot of time and effort configuring, scrubbing (cleaning), formatting, and collecting the input data and are rewarded with a fairly accurate forecasting model. This manual intensive effort is not a one-time exercise; rather, configuring, controlling, and cleaning the input data that is fed to the model has to be continuously maintained by the business. As a result, many previously accurate forecasting models deteriorate over time into less accurate forecasters. Furthermore, some businesses do not have the time nor the resources to properly maintain the input data of their models; so, accurate forecasting models are likely only a luxury for well-financed and larger businesses.

Another problem with forecasting models is that overtime business and consumer conditions, which are relied upon by a given forecast, change. Initially, the changed conditions may have little impact on the accuracy of the model but as time progresses the accuracy decreases. Locating the changed conditions can be challenging even for the well-financed and larger businesses with sufficient internal or contracted resources to maintain the input data for the model. The challenge becomes identifying subtle conditions in the data that when combined are affecting the accuracy of the model, such that these conditions and combinations are properly accounted for and weighted properly by the model.

Still another problem exists because forecasting models process large volumes of input data; that data is a prized competitive asset of the business, which is a closely held and guarded trade secret. Consequently, the processing throughput or time lag for the model to provide a forecast can be substantial, especially when the business does not have access to sufficient hardware. Moreover, even if the business uses external hardware of sufficient processing power, the data often has to be transmitted over a network connection to the external hardware, which degrades network bandwidth and results in substantial time lags in the forecasts returned from the model as the model waits to receive all the needed input data. Thus, many businesses rely on a single forecast from a single model that processes on local networks of the businesses.

### SUMMARY

In various embodiments, methods and a system for two-tiered forecasting are presented.

According to an aspect, a method two-tiered forecasting is presented.

### BRIEF DESCRIPTION OF THE DRAWINGS

FIG. 1 is a diagram of a system for two-tiered forecasting, according to an example embodiment.

FIG. 2 is a diagram of a method for two-tiered forecasting, according to an example embodiment.

FIG. 3 is a diagram of another method for two-tiered forecasting, according to an example embodiment.

### DETAILED DESCRIPTION

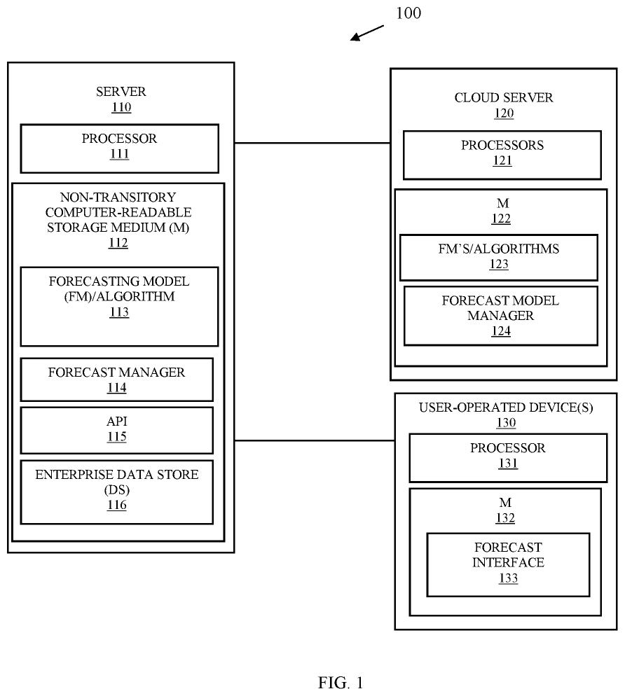

FIG. 1 is a diagram of a system 100 for two-tiered forecasting, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of two-tiered forecasting presented herein and below.

System 100 provides a mechanism by which multiple tiers or levels of forecasting models are processed and optimal forecast data for a given control data item is select from the models. During a first tier or level of forecasting, history data is provided as input to a first forecasting model and first forecast data is returned as output from that first model. The first forecast data comprises a forecast value for the control data item in each interval of time associated with the period of time for which the forecast is being calculated. The history data and the first forecast data are then simultaneously provided or accessed by a plurality of additional forecasting models (second tier or level). Each additional forecasting model is uniquely tuned on different parameters associated with the history data and the first forecast data produced by the initial model.

Each of the additional forecasting models processes concurrently and in parallel to one another and produces its own independent forecast data based on its tuned parameters for the history data and the first forecast data. For each interval of time within the period of time, a mean absolute percentage error rate is then calculated for the initial forecasting model and the additional forecasting models as a whole. For each interval of time within the period of time, an optimal forecast value for the controlled data item is selected from the model that has a smallest deviation from the calculated mean. The selected forecast values of the intervals are assembled as optimal forecast data for the control data item for the period. The optimal forecast data is provided to an application that initiated and requested the original forecast for the controlled data item.

Furthermore, an Application Programming Interface (API) is provided that permits the second tier of forecasting to be activated and the history data provided automatically or made accessible to the additional models of the second tier as soon as the initial forecasting model of the first tier returns its forecast data for the period of time. An error rate for each additional model in each interval of time over the period and each additional model's forecast data for the period are provided or accessible, via the API, to first tier. The optimal forecast values for the intervals within the period of time are assembled in the optimal forecast data based on deviations between each model's error rate and the calculated mean. The API provides the original application, which initially requested a forecast for the control data item over the period of time, with access to the optimal forecast data as an optimal forecast.

As used herein “forecast data” refers to a time series data set. The data set comprises, per interval of time within a period of time associated with a requested forecast: an estimated low-end forecast value for the given interval along with a degree of confidence (this may also be an error rate instead of a confidence value) in the low-end forecast value; an estimated middle forecast value for the given interval along with a degree of confidence/error rate in the middle forecast value; a high-end forecast value for the given interval along with a degree of confidence/error rate in the high-end forecast value; and a selection made in the low-end, middle-end, and high-end that is being provided as the predicted forecast value for the given interval. The low-end, middle, high-end, or predicted “forecast value” for each interval, is an estimated value for the controlled data item during a given interval of time. The “controlled data item” is a type of data for which a prediction/estimation is being requested, such as and by way of example only, an inventory level of a given item/category of items; a profit value for a given item/category of items, a given store/collection of stores, etc.; a media level for a given terminal (such as currency levels, currency levels by denomination, etc.), a given set of terminals, etc.; staffing levels for a given store, a given collection of stores, etc.

The phrase “forecast data” may be used synonymously and interchangeably with the terms “forecast,” “prediction,” and “estimate/estimation” herein and below.

A “forecasting model” refers to one or more algorithms that are trained on history data of an enterprise and/or trained on forecast data to produce forecast data on a given control data item over a given period of time (e.g., day, week, month, quarter of year, year, etc.). A forecasting model can be a statistical-based algorithm, a regression-based algorithm, a neural network-based algorithm, a weighted moving average-based algorithm, a machine learning-based algorithm, etc.

As described herein, the forecasting model is a time-series forecasting model providing forecast data on a given control data item over period of time, wherein the period is broken down further into intervals (e.g., days into hours, weeks into days, months into weeks, etc.) and each interval having an estimated forecast value. Each forecasting model comprises tuning parameters, a “tuning parameter” is a data item type (within the history data (and/or forecast data comprising low-end, middle, high-end, and estimated or predicted forecast values per interval of time over a given period of time)) that is weighted (high or low) within the corresponding algorithm that the model is based on, such that results of the forecast values are more or less dependent to some degree on the values of the weighted data item type. The tuning parameters permit more customized accuracy and reduces the maintenance associated with a given enterprise having to discover and guess at what may and may not work.

It is within this context that the various embodiments of the teachings are now discussed beginning with discussion of FIG. 1.

System 100 comprises a server 110, a cloud server (set of servers) 120, and user-operated devices 130.

Server 100 comprises a processor and a non-transitory computer-readable storage medium 112. Medium 112 comprises executable instructions for a forecasting model (FM)/algorithm 113, a forecast manager 114, an API 115, and interfaces for accessing an enterprise data store 116. Medium 112 may also comprise the actual content data of the enterprise data store 116. The executable instructions when provided to and accessed by processor 111 cause processor 111 to perform operations discussed herein and below with respect to 113-116.

Cloud server 120 comprises a plurality of processors 121 and non-transitory computer-readable storage mediums 122. The mediums 122 comprises executable instructions for one or more additional FM's/algorithms 122 and a forecast model manager 124. Each set of executable instructions when provided to and accessed by the corresponding processor 121 causes the corresponding processor to perform operations discussed herein and below with respect to 123-124.

Each user-operated device 130 comprises a processor 131 and a medium 132. Medium 132 comprises executable instructions for a forecast interface 133. The executable instructions when provided to or accessed by processor 131 cause processor 131 to perform operations discussed herein and below with respect to forecast interface 133.

Initially, a given enterprise/establishment/retailer/financial institution/organization configures and/or trains a first FM 113 to provide forecasts (forecast data) for a given control data item (e.g., media levels, sales, profit, staffing levels, inventory levels, supply levels, etc.) based on that enterprise's historical transaction/business operation history data, which is stored within enterprise data store 116. The FM 113 produces forecast data for the control data item over enterprise-selected periods of time.

One or more addition FM's 123 are subsequently configured and/or trained on the history data and also configured and/or trained on the forecast data that is produced by FM 113 for forecasts on the control data item. Moreover, FM's 123 are tuned on specific tuning parameters that are deemed relevant to the enterprise and the control data item. These tuning parameters may include, by way of example only, location data (e.g., zip code, geographical region, set of streets, city, state, etc.), terminal/device availability or status, census data for the population census at a given location (defined by the location data), clustering by weather data or weather patterns (raining, windy, storming, power outages, etc.—obtainable via a web interface from a weather service even when not available in the history data), clustering by latitude/longitude. Other tuning parameters may also be used to further tune the FM's 123, such as holiday schedules at the location, etc.

Once FM 113 and the one or more FM's 123 are configured and tuned for a given control data item of a given enterprise's history data (and forecast data for the one or more FM's 123), system 100 operates in the manners that follow.

Forecast interface 133 requests from forecast manager 114 that a forecast be provided for the control data item using history data of enterprise data store 116 for a given period of time. The requests can be initiated by a user that operates device 130 or can be automatically made based on a schedule or an event that triggers the request to be sent from interface 133 to manager 114.

Forecast manager 114 obtains or loads the needed history data from data store 116, such that it is accessible to FM 113. FM 113 is then initiated with the history data provided as input. This causes FM 113 to produce as output forecast data over the period of time on the control data item.

Once the forecast data is provided from FM 113, forecast manager 114 uses API 115 to call and interact with forecast model manager 124 of cloud server 120. Forecast manager 114 provides as input an identifier for the enterprise, an identifier for the control data item, the history data, and the forecast data produced by FM 113. Based on the enterprise identifier and the control data item, forecast model manager 124 identifies one or more additional FM's 123 that are to be processed in parallel with one another on the history data and the forecast data to produce one or more additional sets of forecast data for the controlled data item.

Once the one or more additional FM's 123 produce their forecast data, forecast model manager 124 provides the one or more sets of forecast data back to forecast manager 114. Forecast manager 114 now has access to two or more sets of forecast data for the control data item over the period of time, the forecast data produced by FM 113 and the one or more additional sets of forecast data produced by the one or more FM's 123.

For each interval of time within the period of time, forecast manager 114 performs the following operations. A mean absolute percentage error (MAPE) rate for FM 113 and FM's is calculated for the interval of time. (Note FM's 113 and 123 may provide a confidence value from which the error rate can be calculated; for example, a 90% confidence rate can be calculated as a 10% error rate.) Each error rate of FM's 113 and 123 is then compared for the interval against the MAPE to obtain a deviation value for each FM 113 and 123 as compared to the MAPE. The smallest deviation value is selected as an optimal FM 113 or 123 for the interval. The estimated value selected by the optimal FM 132 or 132 with its forecast data is then selected as an optimal forecast value for the interval and the optimal FM's low-end, middle, and high-end forecast values for that interval are selected as the interval's optimal forecast data. Each interval is iterated by forecast manager 114 in this manner until an optimal forecast data over the period has been assembled or produced.

Once the optimal forecast data over the period for the control data item is resolved, forecast manager 114 provides the optimal forecast data back to forecast interface 113 as a response to the initial request for the forecast on the given control data item for the given period. The optimal forecast data can be provided in any number of ways, such as via a pointer to a table within the enterprise data store 116 for access via interface 133 or for further automated processing by 133, via a data table, via an interactive graph, via an attached file, or via any combination of these.

In an embodiment, forecast manager 114 is an existing forecast manager 114 that is enhanced with API 115 for interacting with forecast model manager 124 and selecting, assembling, and/or generating a modified and optimal forecast data originally provided by FM 113.

In an embodiment, forecast model manager 124 performs the selecting, assembling, and/or generating of the modified and optimal forecast data on behalf of forecast manager 114 in the manner that was described above with forecast manager 114. In this embodiment, an existing forecast manager 114 is enhanced to use API 115 and call forecast model manager 124 once FM 113 provides its forecast data and enhanced to use the optimal forecast data returned as output from forecast model manager 124.

In an embodiment, the controlled data item is currency levels (total currency and/or denomination totals for each denomination of currency) of a depository of an Automated Teller Machine (ATM) or set of ATMs within a given region.

In an embodiment, the controlled data item is fuel levels of fuel pumps at a convenience store or set of convenience stores.

In an embodiment, the controlled data item is an item inventory level, an item category level for a category of items, or an item grouping level for a grouping of items at a grocery store, a retail store, or set of stores.

In an embodiment, the controlled data item is food item level, or a staffing level needed at a restaurant or a set of restaurants.

In an embodiment, the controlled data items is a hotel room occupancy rate at a given hotel or set of hotels.

In an embodiment, the controlled data item is a rental car rental rate or inventory level at a given rental car outlet or set of rental car outlets.

In an embodiment, the controlled data item is a customer traffic rate at a given retail store or set of retail stores.

In an embodiment, the controlled data item is a sales volume/rate or profit margin rate for a given retailer or set of retailers.

In an embodiment, the controlled data item is an item demand rate for item at a given retailer or set of retailers.

In an embodiment, device 130 is a desktop computer, a server, a transaction terminal (Self-Service Terminal (SST), Point-Of-Sale (POS) terminal, an ATM, or a kiosk), a laptop, a tablet, a phone, or a wearable processing device.

In an embodiment, interface 133 is provided as a mobile application or as a browser-based interface from or on device 130.

In an embodiment, API 115 is a Representational State Transfer (REST) API.

In an embodiment, the processing discussed above for system 100 is encapsulated via a RESTful interface utilizing a Python® framework where the history data is loaded in DataFrames® of an Oracle® database via Apache Spark®.

In an embodiment, the FM's 123 are machine-learning algorithms that implement regression on location-based tuning parameters as regressors.

System 100 improves the accuracy of forecasts by utilizing an enterprise's FM 113 (first tier) for that enterprise's history data and piping the forecast data to a cloud-based forecast model manager 124 where one or multiple additional FM's 123 (second tier) are trained on that forecast data and tuned on additional parameters associated with the history data to produce additional potential sets of forecast data for the controlled data item. The additional tuned parameters of FM's 123 reduce maintenance expense of an enterprise that is associated with scrubbing, cleaning, and formatting their history data and reduce the vigilance with which FM 113 has to be tuned by the enterprise. When more than one additional FM 123 is processed, each of the additional FM 123 are processed in parallel, which substantially improves response times (processing throughputs) in providing a forecast. An optimal forecast data is then constructed, assembled, and/or generated from all of the forecast data for each interval of time within the period associated with the forecast.

Moreover, system 100 can be integrated and processed via an API 115 such that integration is seamless and transparent to any user that operates device 130 and interface 133 and such that any modifications needed to an existing forecast manager to provided enhanced forecast manager 114 are minimal.

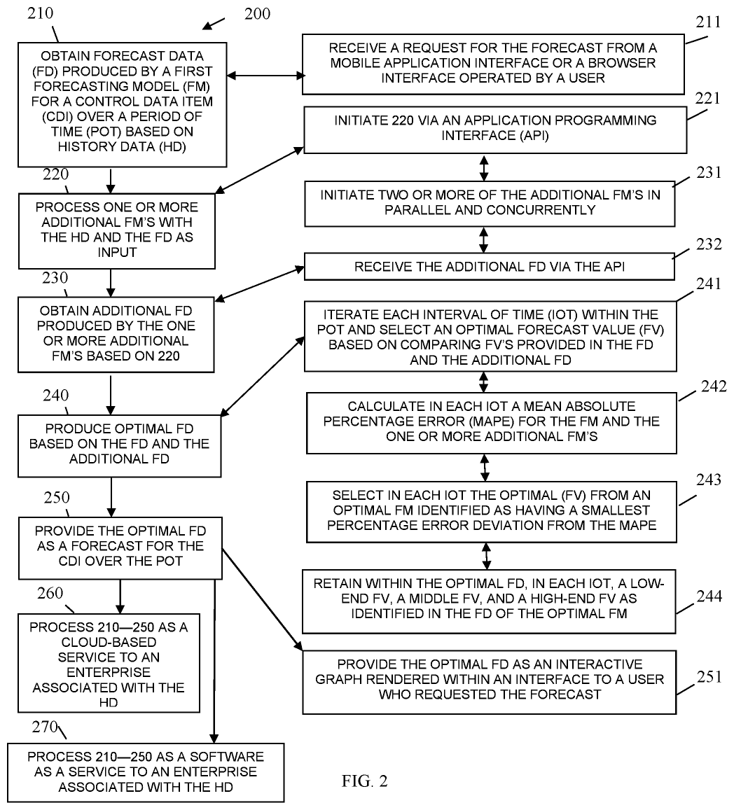

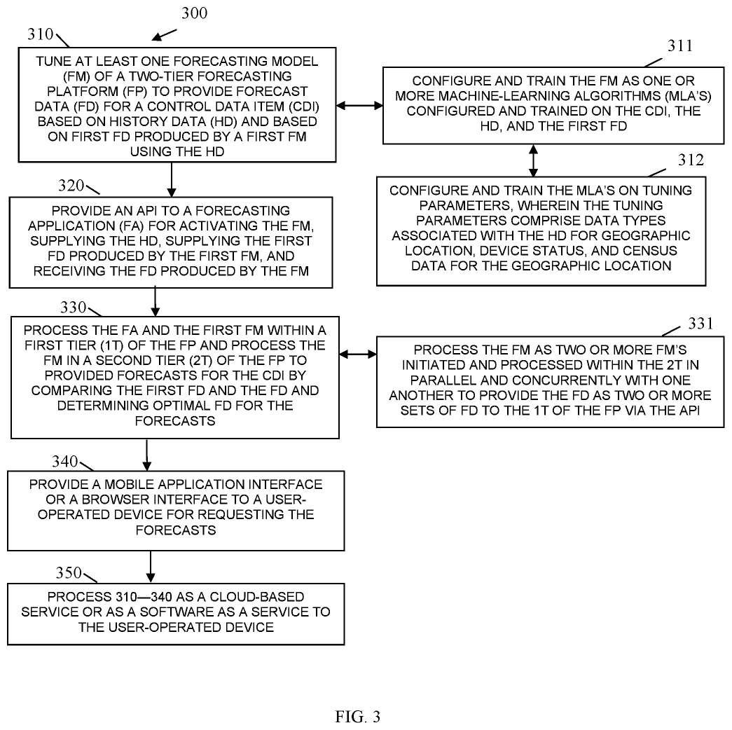

The above-referenced embodiments and other embodiments are now discussed with reference to the FIGS. 2-3.

FIG. 2 is a diagram of a method 200 for two-tiered forecasting, according to an example embodiment. The software module(s) that implements the method 200 is referred to as a “forecaster.” The forecaster is implemented as executable instructions programmed and residing within memory and/or a non-transitory computer-readable (processor-readable) storage medium and executed by one or more processors of a device or multiple devices. The processor(s) of the device that executes the forecaster are specifically configured and programmed to process the forecaster. The forecaster has access to one or more network connections during its processing. The network connections can be wired, wireless, or a combination of wired and wireless.

In an embodiment, the device(s) that executes the forecaster is server 110 and/or cloud server 120.

In an embodiment, the forecaster is all of or some combination of 113, 114, 115, 123, and/or 124.

In an embodiment, the forecaster performs the processing discussed above with system 100 for purposes of improving the accuracy of forecasts on given control data items over a given period of time.

In an embodiment, the forecaster is provided as a SaaS (Software-as-a-Service) to a plurality of enterprises.

At 210, the forecaster obtains forecast data produced by a first forecasting model (such as model 113) for a control data item over a period of time based on history data.

In an embodiment, at 211, the forecaster receives a request for the forecast from a mobile application interface 133 or a browser interface 133 operated by a user.

At 220, the forecaster processes one or more additional forecasting models (such as 123) and provides the history data and the first forecast data as input to the additional forecasting models.

In an embodiment, at 221, the forecaster initiates the processing at 220 via an API 115.

At 230, the forecaster obtains additional forecast data produced by the additional forecasting models based on 220.

In an embodiment of 220 and 230, at 231, the forecaster initiates two or more of the additional forecasting models in parallel and concurrently for parallel processing of the two or more additional forecasting models.

In an embodiment of 231 and at 232, the forecaster receives the additional forecast data via the API 115.

At 240, the forecaster produces optimal forecast data based on the forecast data and the additional forecast data.

In an embodiment, at 241, the forecaster iterates each interval of time within the period of time and selects an optimal forecast value for that interval based on comparing the forecast data and the additional forecast data.

In an embodiment of 241 and at 242, the forecaster calculates, in each interval, a mean absolute percentage for the first forecasting model and the additional forecasting model.

In an embodiment of 242 and at 243, the forecaster selects, in each interval of time, the optimal forecast value for that interval from an optimal forecasting model. The optimal forecasting model for the interval is selected based on having a smallest percentage error deviation from the mean absolute percentage error calculated for the interval at 242. That is, for each interval a given forecasting model includes/provides a confidence value or an error value within their forecast value and the model having the smallest deviation from the mean absolute percentage error within the interval is selected as the optimal forecasting model for the interval and its corresponding forecast value for the interval is identified as the optimal forecast value of the interval.

In an embodiment of 243 and at 244, the forecaster retains within the optimal forecast data, in each interval of time, a low-end forecast value, a middle forecast value, and a high-end forecast value as identified in the forecast data of the optimal forecasting model. So, each interval of time within the optimal forecast data comprises an optimal forecast value, a low-end forecast value, a middle forecast value, and a high-end forecast value along with the error or confidence level rates for each forecast value.

At 250, the forecaster provides the optimal forecast data as a forecast for the control data item over the period of time.

In an embodiment, at 251, the forecaster provides the optimal forecast data as an interactive graph rendered within an interface 133 to a user who requested the forecast.

In an embodiment, at 260, the forecaster is processed as a cloud-based service to an enterprise associated with the history data.

In an embodiment, at 270, the forecaster is processed as a SaaS to an enterprise associated with the history data.

FIG. 3 is a diagram of another method 300 for two-tiered forecasting, according to an example embodiment. The software module(s) that implements the method 300 is referred to as a “two-tiered forecast manager.” The two-tiered forecast manager is implemented as executable instructions programmed and residing within memory and/or a non-transitory computer-readable (processor-readable) storage medium and executed by one or more processors of a device or multiple devices. The processors that execute the two-tiered forecast manager are specifically configured and programmed to process the two-tiered forecast manager. The two-tiered forecast manager has access to one or more network connections during its processing. The network connections can be wired, wireless, or a combination of wired and wireless.

In an embodiment, the device(s) that executes the two-tiered forecast manager is server 110 and/or cloud server 120.

In an embodiment, the two-tiered forecast manager is all or some combination of 113, 114, 115, 123, 124, 133, and/or the method 200.

The two-tiered forecast manager presents another and, in some ways, enhanced processing perspective to that which was described above with the method 200 of FIG. 2 and system 100 of FIG. 1.

At 310, the two-tiered forecast manager tunes at least one forecasting model (such as 123) of a two-tiered forecasting platform (system 100) to provide forecast data for a control data item based on history data and based on first forecast data produced by a first forecasting model (such as 113) using the history data.

In an embodiment, at 311, the two-tiered forecast manager configures and trains the forecasting model(s) 123 as one or more machine-learning algorithms that are configured and trained on the control data item, the history data, and the first forecast data.

In an embodiment of 311 and at 312, the two-tiered forecast manager configures and trains the machine-learning algorithms on tuning parameters. The tuning parameters comprise data types associated with the history data for geographic location, device/terminal status, and census data for the geographical location. In an embodiment, the tuning parameters may further include clustering by latitude/longitude, weather patterns, holiday schedules by location or geography, etc.

At 320, the two-tiered forecast manager provides an API (such as 115) to a forecasting application (such as forecast manager 114) for activating the forecasting model(s) 123, supplying the history data, supplying the first forecast data produced by the first forecasting model 113, and receiving the forecast data produced by the forecasting model(s) 123.

At 330, the two-tiered forecast manager processes the first forecasting application 114 and the first forecasting model 113 within a first tier of the two-tier forecasting platform 100. The two-tiered forecast manager also processes the forecasting model(s) 123 within a second tier of the two-tier forecasting platform 100. This causes platform 100 to provide forecasts for the control data item by comparing the first forecast data (of the first tier) and the forecast data (of the second tier) and determining optimal forecast data for the forecasts.

In an embodiment, at 331, the two-tiered forecast manager processes the forecasting model(s) 123 as two or more forecasting models that are initiated and processed within the two-tier forecasting platform 100 in parallel and concurrently with one another to provide the forecast data (of the second tier) as two or more sets of forecast data to the first tier of the platform 100 via the API 115.

At 340, the two-tiered forecast manager provides a mobile application interface 133 or a browser interface 133 to a user-operated device 130 for requesting the forecasts and for receiving the optima forecast data.

In an embodiment, at 350, the two-tiered forecast manager is processed as a cloud-based service or as a SaaS to the user-operated device 130.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
obtaining forecast data produced by a first forecasting model for a control data item over a period of time based on history data;
processing one or more additional forecasting models with the history data and the forecast data;
obtaining additional forecast data produced by the one or more additional forecasting models based on the processing;
producing optimal forecast data based on the forecast data and the additional forecast data; and
providing the optimal forecast data as a forecast for the control data item over the period of time.

2. The method of claim 1 further comprising, process the method as a cloud-based service to an enterprise associated with the history data.

3. The method of claim 1 further comprising, processing the method as a Software-as-a-Service (SaaS) provided to an enterprise associated with the history data.

4. The method of claim 1, wherein obtaining the forecast data further includes receiving a request for the forecast from a mobile application interface or a browser interface operated by a user.

5. The method of claim 1, wherein processing further includes initiating the processing via an Application Programming Interface (API).

6. The method of claim 5, wherein initiating further includes initiating two or more of the additional forecasting models in parallel and concurrently.

7. The method of claim 6, wherein obtaining the additional forecast data further includes receiving the additional forecast data via the API.

8. The method of claim 1, wherein producing further includes iterating each interval of time within the period of time and selecting an optimal forecast value for the interval of time based on comparing forecast values provided in the forecast data and the additional forecast data.

9. The method of claim 8, wherein iterating further includes calculating, in each interval of time, a mean absolute percentage error for the forecasting model and the one or more additional forecasting models.

10. The method of claim 9, wherein calculating further includes selecting, in each interval of time, the optimal forecast value estimated by an optimal forecasting model that is identified as having a percentage error with a smallest deviation from the mean absolute percentage error among the forecasting model and the one or more forecasting models.

11. The method of claim 10, wherein selecting further includes retaining within the optimal forecast data, in each interval of time, a low-end forecast value, a middle forecast value, and a high-end forecast value as identified in the forecast data of the optimal forecasting model.

12. The method of claim 1, wherein providing further includes providing the optimal forecast data as an interactive graph rendered within an interface to a user who requested the forecast.

13. A method, comprising:
tuning at least one forecasting model of a two-tier forecasting platform to provide forecast data for a control data item based on history data and based on first forecast data produced by a first forecasting model using the history data;
providing an Application Programming Interface (API) to a forecasting application for activating the at least one forecasting model, supplying the history data for the control data item, supplying the first forecast data produced by the first forecasting model, and receiving the forecast data produced by the at least one forecasting model; and
processing the forecasting application and the first forecasting model within a first tier of the two-tier forecasting platform and processing the at least one forecasting model in a second tier of the two-tier forecasting platform to provide forecasts for the control data item by comparing the first forecast data and the forecast data and determining optimal forecast data for the forecasts.

14. The method of claim 13 further comprising, providing a mobile application interface or a browser interface to a user-operated device for requesting the forecasts.

15. The method of claim 14 further comprising, processing the method as a cloud-based service of as a Software-as-a-Service (SaaS) to the user-operated device.

16. The method of claim 13, wherein tuning further includes configuring and training the at least one forecasting model as one or more machine-learning algorithms configured and trained on the control data item, the history data and the first forecast data produced by the first forecasting model.

17. The method of claim 16, wherein configuring and training further includes configuring and training the one or more machine-learning algorithms on tuning parameters, wherein the tuning parameters comprise data types associated with the history data for geographic location, device status, and census data for the geographic location.

18. The method of claim 13, wherein processing further includes initiating and processing two or more forecasting models within the second tier of the two-tier forecasting platform in parallel and concurrently with one another to provide the forecast data as two or more sets of forecast data to the first tier of the two-tier forecasting platform via the API.

19. A system, comprising:
a two-tiered forecasting platform comprising a server and a cloud server;
the server is configured to process as a first tier of the two-tiered forecasting platform; and
the cloud server is configured to process as a second tier of the two-tiered forecasting platform;
wherein the server is configured to: receive a request for a forecast from an interface of a user-operated device for a control data item over a period of time, obtain history data defined in the request, process a first forecasting model using the history data as input, process an Application Programming Interface (API) to provide first forecast data produced by the first forecasting model to the cloud server via the API, receive additional forecast data from the cloud server via the API, generate optimal forecast data selected from the first forecast data and the additional forecast data for each interval of time within the period of time, and render the optimal forecast data in the interface to the user-operated device as the forecast;
wherein the cloud server is configured to: receive the history data and the first forecast data from the server via the API, simultaneously provide the history data and the first forecast data as input to two or more additional forecasting models to process concurrently and in parallel with one another, obtain the additional forecast data as output produced by the two or more additional forecasting models, and provide the two or more additional forecasting models to the server via the API.

20. The system of claim 19, wherein the control data item is a currency level projected for one or more terminals, denomination totals projected for denominations of currency projected for the one or more terminals, an item inventory level projected for an item or an item category that comprises multiple items, a room occupancy rate projected for one or more hotels, a customer traffic level projected for one or more retailers, a rental car inventory level projected for one or more car rental stores, a fuel level projected for one or more fuel pumps of one or more convenience stores, a sales volume projected for the item or the item category, a profit margin projected for one or more stores, or an item demand level projected for the item or the item category.
